(19) United States
(12) Patent Application Publication
(10) Pub. No.: US 2025/0106151 A1
(43) Pub. Date: Mar. 27, 2025

(54) DETERMINING AND UTILIZING ENERGY EFFICIENT LINKS AND NETWORK DEVICES IN A NETWORK

(71) Applicant: Juniper Networks, Inc., Sunnyvale, CA (US)

(72) Inventors: Vyasraj SATYANARAYANA, Bangalore (IN); Srihari Ramachandra SANGLI, Bengaluru (IN); Ronald BONICA, Reston, VA (US); Raja KOMMULA, Cupertino, CA (US)

(21) Appl. No.: 18/645,698

(22) Filed: Apr. 25, 2024

(30) Foreign Application Priority Data
Sep. 26, 2023 (IN) 202341064503

(51) Int. Cl. H04L 45/00; H04L 43/10

(52) U.S. Cl. CPC H04L 45/70; H04L 43/10

(57) ABSTRACT

A device may receive a traceroute request for a path between two edge devices of a network, and may generate a response indicating a bit cost and an energy efficiency identifier associated with the device. The device may provide the traceroute request to a plurality of network devices associated with a path between the two edge devices, and may receive a plurality of responses indicating respective bit costs and energy efficiency identifiers associated with the plurality of network devices. The device may generate a traceroute response that includes the response and the plurality of responses, and may provide the traceroute response to one of the two edge devices to indicate, to the one of the two edge devices, an energy efficiency associated with the path.

### CROSS-REFERENCE TO RELATED APPLICATION

This Patent Application claims priority to India Provisional Patent Application No. 202341064503, filed on Sep. 26, 2023, entitled “SYSTEMS AND METHODS FOR PROVIDING ENERGY EFFICIENT NETWORKS,” and assigned to the assignee hereof. The disclosure of the prior Application is considered part of and is incorporated by reference into this Patent Application.

### BACKGROUND

Today, industries are providing energy efficient (e.g., “green”) product designs in an attempt to address climate change and diminishing natural resources. In telecommunication networks, energy efficiency can be defined as an energy cost required to exchange a bit of information across a link (e.g., referred to as a “bit cost” or “greenness”). A bit cost represents power usage of a device for transmitting and receiving a single bit of data. A bit cost can be represented either in absolute terms or as a relative normalized value of power consumption of the device. A bit cost can also be represented in other ways, such as a power consumption in transmitting and receiving traffic for a certain throughput.

### SUMMARY

Some implementations described herein relate to a method. The method may include receiving a traceroute request for a path between two edge devices of a network, and generating a response indicating a bit cost and an energy efficiency identifier associated with the device. The method may include providing the traceroute request to a first plurality of network devices associated with a first path between the two edge devices, and receiving a first plurality of responses indicating respective bit costs and energy efficiency identifiers associated with the first plurality of network devices. The method may include generating a first traceroute response that includes the response and the first plurality of responses, and providing the first traceroute response to one of the two edge devices to indicate, to the one of the two edge devices, an energy efficiency associated with the first path.

Some implementations described herein relate to a device. The device may include one or more memories and one or more processors. The one or more processors may be configured to receive a traceroute request for a path between two edge devices of a network, and generate a response indicating a bit cost and an energy efficiency identifier associated with the device. The one or more processors may be configured to provide the traceroute request to a plurality of network devices associated with a plurality of paths between the two edge devices, and receive a plurality of responses indicating respective bit costs and energy efficiency identifiers associated with the plurality of network devices. The one or more processors may be configured to generate a traceroute response that includes the response and the plurality of responses, and provide the traceroute response to one of the two edge devices to indicate, to the one of the two edge devices, energy efficiencies associated with the plurality of paths.

Some implementations described herein relate to a non-transitory computer-readable medium that stores a set of instructions. The set of instructions, when executed by one or more processors of a device, may cause the device to receive a traceroute request for a path between two edge devices of a network, and generate a response indicating a bit cost and an energy efficiency identifier associated with the device. The set of instructions, when executed by one or more processors of the device, may cause the device to provide the traceroute request to a first plurality of network devices associated with a first path between the two edge devices, and receive a first plurality of responses indicating respective bit costs and energy efficiency identifiers associated with the first plurality of network devices. The set of instructions, when executed by one or more processors of the device, may cause the device to generate a first traceroute response that includes the response and the first plurality of responses, and provide the first traceroute response to one of the two edge devices to indicate, to the one of the two edge devices, an energy efficiency associated with the first path. The set of instructions, when executed by one or more processors of the device, may cause the device to provide the traceroute request to a second plurality of network devices associated with a second path between the two edge devices, and receive a second plurality of responses indicating respective bit costs and energy efficiency identifiers associated with the second plurality of network devices. The set of instructions, when executed by one or more processors of the device, may cause the device to generate a second traceroute response that includes the response and the second plurality of responses, and provide the second traceroute response to the one of the two edge devices to indicate, to the one of the two edge devices, an energy efficiency associated with the second path.

### BRIEF DESCRIPTION OF THE DRAWINGS

FIGS. 1A-1H are diagrams of an example associated with determining and utilizing energy efficient links and network devices in a network.

FIG. 2 is a diagram of an example environment in which systems and/or methods described herein may be implemented.

FIGS. 3 and 4 are diagrams of example components of one or more devices of FIG. 2.

FIG. 5 is a flowchart of an example process for determining and utilizing energy efficient links and network devices in a network.

### DETAILED DESCRIPTION

The following detailed description of example implementations refers to the accompanying drawings. The same reference numbers in different drawings may identify the same or similar elements.

The greenness of a product (e.g., a network device or a link) may also be defined by an energy certificate rating issued by a competent certifying authority. Bit cost metrics and greenness metrics will play a very useful role in network design and planning, service provisioning in a network, validating a solution in a network, and/or the like. Furthermore, there are many scenarios in which knowing the bit cost metric and the greenness metric of a network link, network device, and/or path will be useful. For example, a customer may purchase a green networking service from a network service provider. However, current techniques for managing networks fail to provide such metrics for performing such services. With current techniques for managing networks, the customer would be unable to validate that the service provided by the network service provider is compliant with a purchased green service level agreement. A network service provider may be required to manage a network intelligently during peak and off-peak network traffic conditions. The network service provider may wish to utilize a bit cost metric and a greenness metric of a link to intelligently manage the network, but is unable to retrieve the metrics for the link.

Thus, current techniques for managing networks consume computing resources (e.g., processing resources, memory resources, communication resources, and/or the like), networking resources, and/or the like are associated with failing to utilize bit cost metrics and greenness metrics for network devices and links of a network, utilizing energy inefficient network devices and/or links based on failing to utilize the bit cost metrics and the greenness metrics, handling customer complaints associated with failing to utilize the bit cost metrics and the greenness metrics, failing to satisfy government regulations based on failing to utilize the bit cost metrics and the greenness metrics, and/or the like.

Some implementations described herein relate to determining and utilizing energy efficient links and network devices in a network. For example, a network device may receive a traceroute request for a path between two edge devices of a network, and may generate a response indicating a bit cost and an energy efficiency identifier associated with the device. The network device may provide the traceroute request to a plurality of network devices associated with a path between the two edge devices, and may receive a plurality of responses indicating respective bit costs and energy efficiency identifiers associated with the plurality of network devices. The network device may generate a traceroute response that includes the response and the plurality of responses, and may provide the traceroute response to one of the two edge devices to indicate, to the one of the two edge devices, an energy efficiency associated with the path.

In this way, the network device enables determining and utilizing energy efficient links and network devices in a network. For example, the network device may utilize operations, administration, and maintenance (OAM) tools (e.g., traceroute and/or ping) to determine and utilize the energy efficient links and network devices in the network. To determine and utilize the bit cost metrics and the greenness metrics of links and network devices, the network device may enable bit cost metrics and green certificates of links and network devices to be included in traceroute requests/responses or ping requests/responses, as part of a protocol exchange with the links and the network devices. This will enable a network service provider to determine and utilize the energy efficient links and network devices in the network (e.g., for traffic path calculations). Thus, the network device conserves computing resources, networking resources, and/or the like that would otherwise have been consumed by failing to utilize bit cost metrics and greenness metrics for network devices and links of a network, utilizing energy inefficient network devices and/or links based on failing to utilize the bit cost metrics and the greenness metrics, handling customer complaints associated with failing to utilize the bit cost metrics and the greenness metrics, failing to satisfy government regulations based on failing to utilize the bit cost metrics and the greenness metrics, and/or the like.

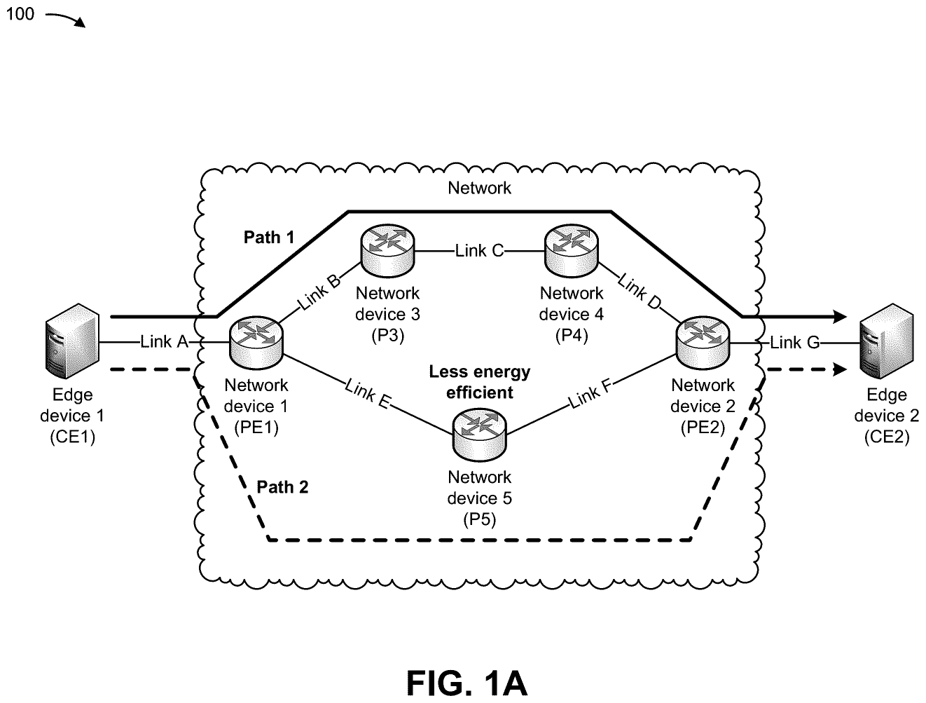

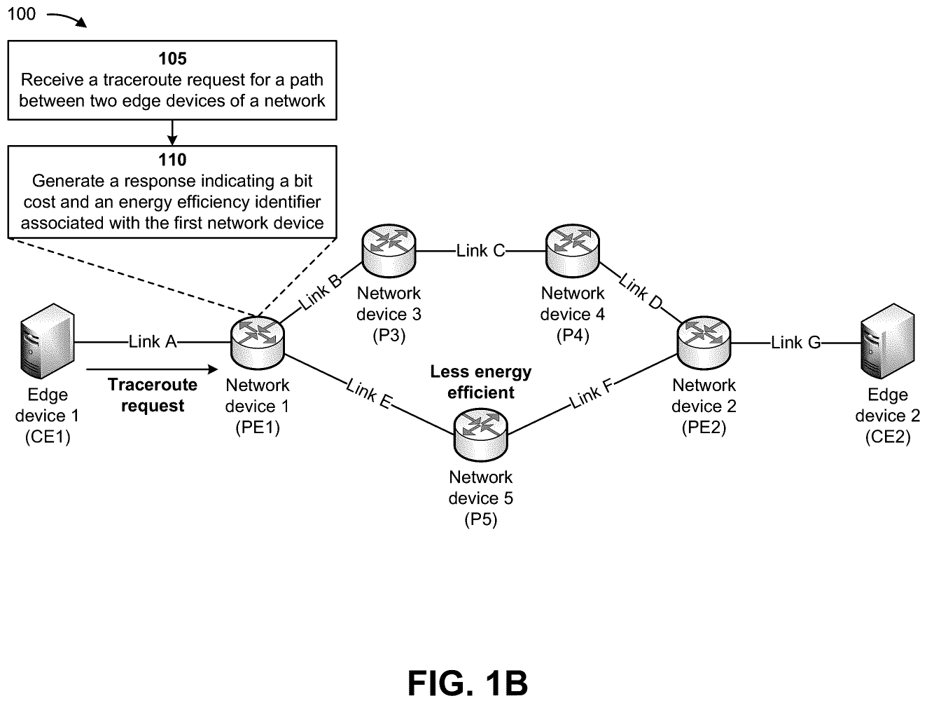

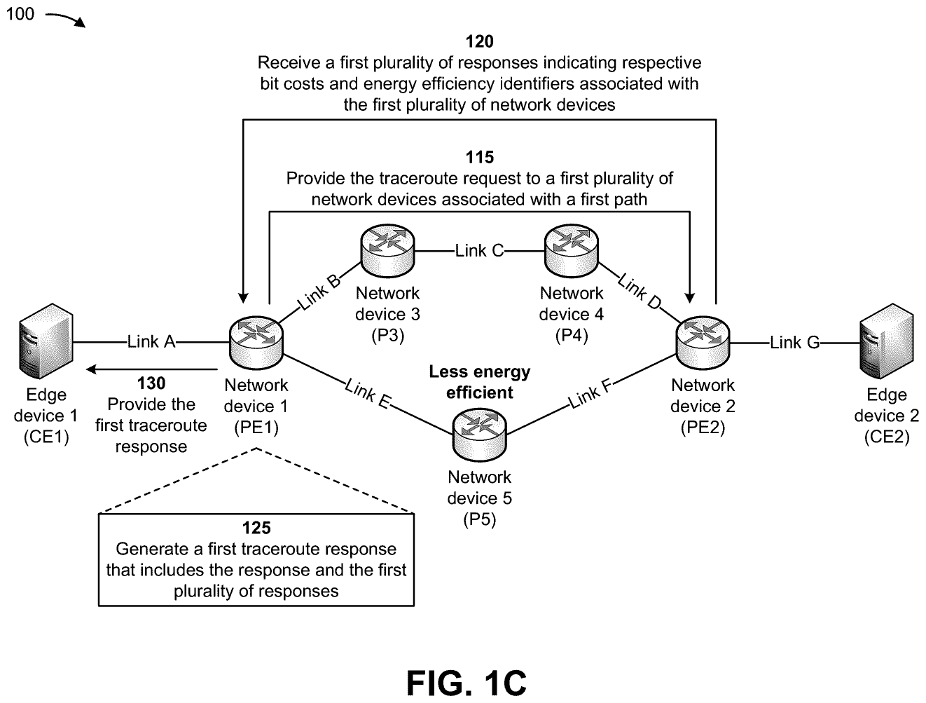

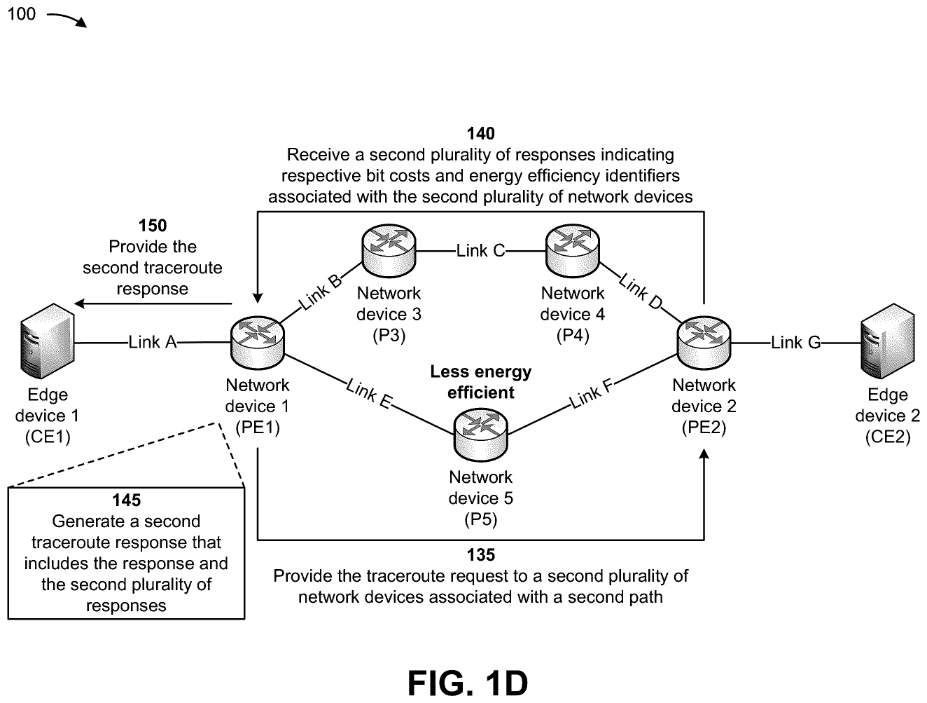

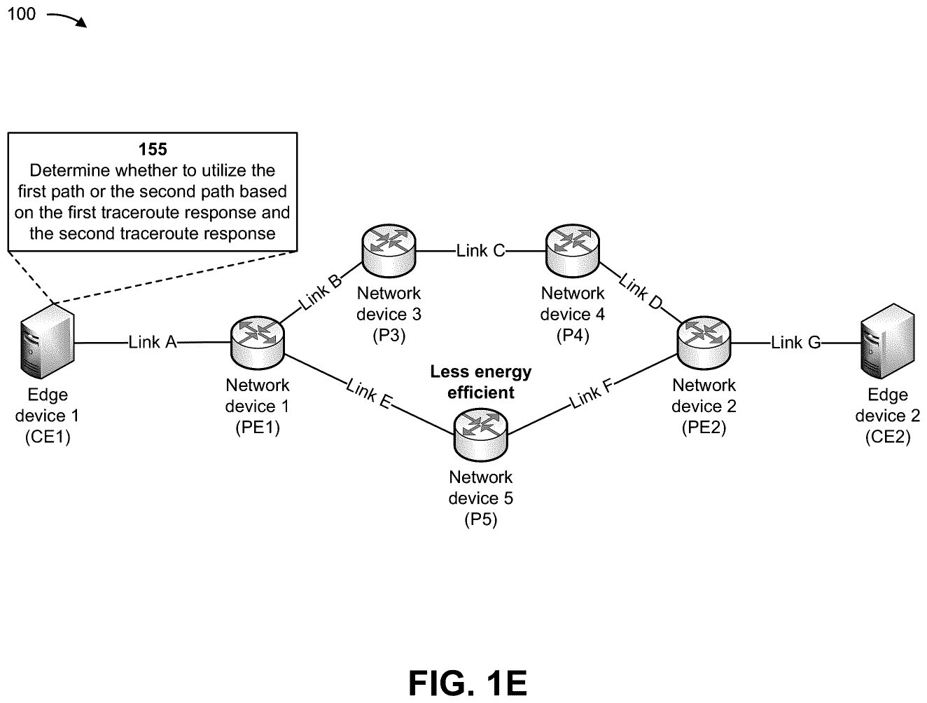

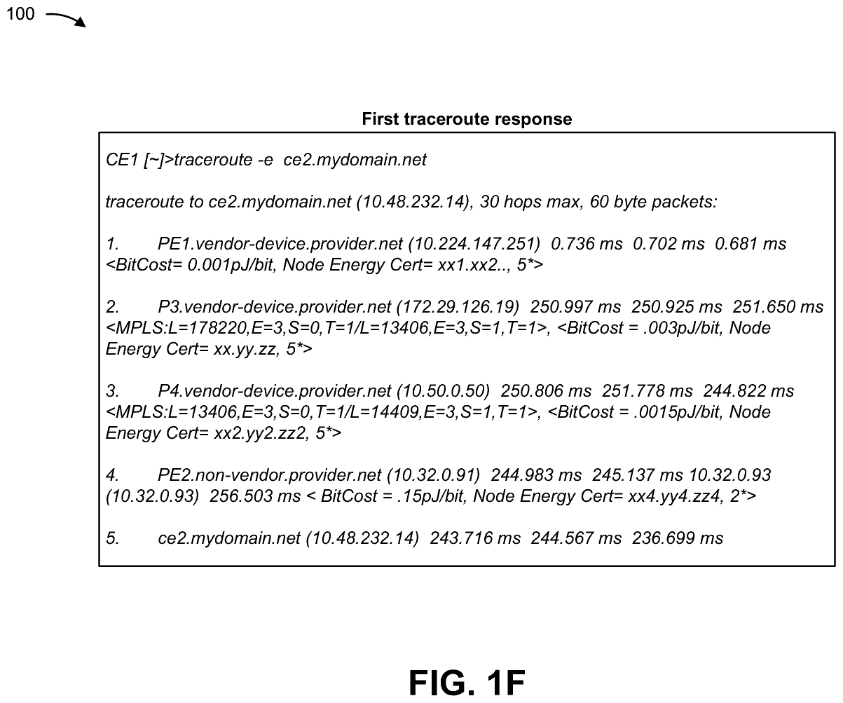

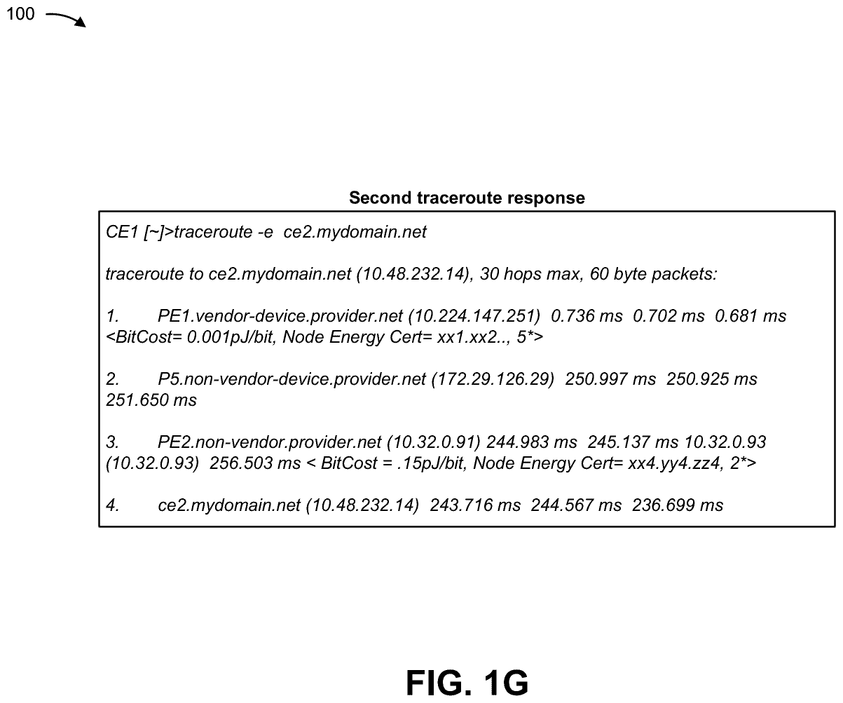

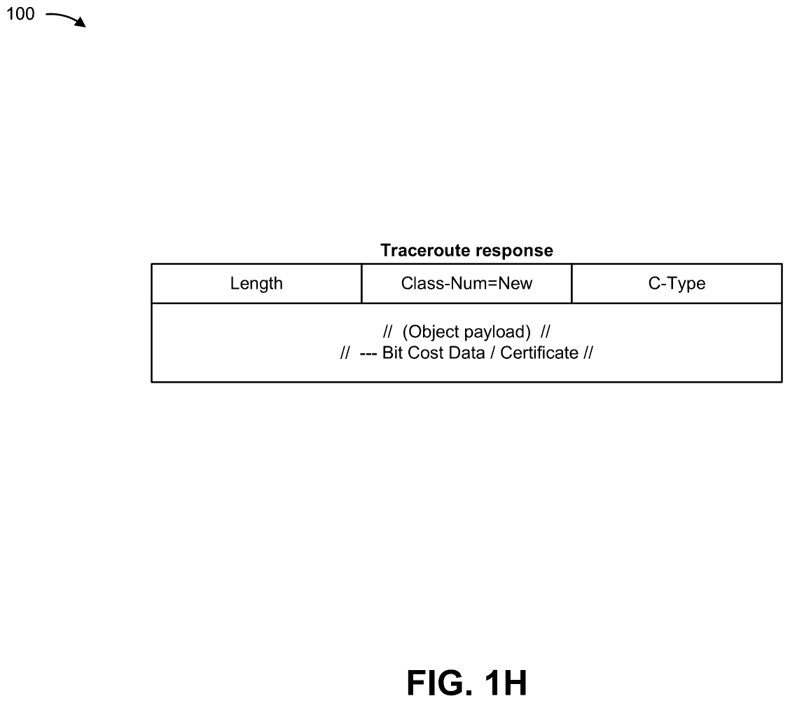

FIGS. 1A-1H are diagrams of an example 100 associated with determining and utilizing energy efficient links and network devices in a network. As shown in FIGS. 1A-1H, the example 100 includes edge devices associated with a network. The edge devices may include a first edge device (e.g., edge device 1 or customer edge 1 (CE1)) and a second edge device (e.g., edge device 2 or customer edge 2 (CE2)). The network may include multiple network devices, such as a first network device (e.g., network device 1 or provider edge 1 (PE1)), a second network device (e.g., network device 2 or provider edge 2 (PE2)), a third network device (e.g., network device 3 or provider 3 (P3)), a fourth network device (e.g., network device 4 or provider 4 (P4)), and a fifth network device (e.g., network device 5 or provider 5 (P5)). A first link (e.g., link A) may be provided between the first edge device and the first network device, a second link (e.g., link B) may be provided between the first network device and the third network device, a third link (e.g., link C) may be provided between the third network device and the fourth network device, a fourth link (e.g., link D) may be provided between the fourth network device and the second network device, a fifth link (e.g., link E) may be provided between the first network device and the fifth network device, a sixth link (e.g., link F) may be provided between the fifth network device and the second network device, and a seventh link (e.g., link G) may be provided between the second network device and the second edge device. Further details of the edge devices, the network, the network devices, and the links are provided elsewhere herein.

As shown in FIG. 1A, the first network device, the second network device, the third network device, and the fourth network device may be energy efficient network devices, and the fifth network device may not be an energy efficient network device (e.g., less energy efficient than the other network devices). In some implementations, the fifth network device may be an older network device than the other network devices and thus less energy efficient than the other network devices. There may be two paths in the network connecting the first edge device and the second edge device: a first path connecting the first edge device, the first network device, the third network device, the fourth network device, the second network device, and the second edge device (e.g., Path 1=CE1−PE1−P3−P4−PE2−CE2) and a second path connecting the first edge device, the first network device, the fifth network device, the second network device, and the second edge device (e.g., Path 2=CE1−PE1−P5−PE2−CE2). In some implementations, the second path may be shorter than the first path. However, since the fifth network device is less energy efficient, the first path may be more energy efficient than the second path. A customer of the network may wish for traffic to flow via the most energy efficient path (e.g., the first path). The customer and/or a network service provider may verify that traffic is flowing via the most energy efficient path by utilizing the implementations described herein.

As shown in FIG. 1B, and by reference number 105, the first network device may receive a traceroute request for a path between two edge devices of a network. For example, in order to identify the most energy efficient path through the network, the first edge device may generate a traceroute request for a path between the first edge device and the second edge device of the network. In some implementations, the traceroute request may include a request for energy efficiencies associated with different paths between the first edge device and the second edge device. The first edge device may provide the traceroute request to the first network device, and the first network device may receive the traceroute request from the first edge device. In some implementations, the traceroute request may include an Internet control message protocol (ICMP) traceroute request, a user datagram protocol (UDP) traceroute request, a transmission control protocol (TCP) traceroute request, a Layer 2 connectivity fault management (CFM) link trace message (LTM), and/or the like.

As further shown in FIG. 1B, and by reference number 110, the first network device may generate a response indicating a bit cost and an energy efficiency identifier associated with the first network device. For example, the traceroute request may cause the first network device to generate a response to the request for the energy efficiencies associated with different paths between the first edge device and the second edge device. The response generated by the first network device may include a bit cost and an energy identifier associated with the first network device. In one example, the response indicating the bit cost and the energy efficiency identifier associated with the first network device may include the following information: PE1.vendor-device.provider.net (10.224.147.251) 0.736 ms 0.702 ms 0.681 ms <BitCost=0.001pJ/bit, Node Energy Cert=xx1.xx2 . . . , 5*>.

In some implementations, the response indicating the bit cost and the energy efficiency identifier associated with the first network device may include an ICMP traceroute response, a UDP traceroute response, a TCP traceroute response, a Layer 2 CFM link trace response (LTR) message, and/or the like. In some implementations, the energy efficiency identifier associated with the first network device may include an energy certificate rating associated with the device and generated by a certifying authority. In some implementations, the response may include type-length-value (TLV) fields indicating the bit cost and the energy efficiency identifier of the device.

As shown in FIG. 1C, and by reference number 115, the first network device may provide the traceroute request to a first plurality of network devices associated with a first path. For example, the first network device may identify the first path connecting the first edge device, the first network device, the third network device, the fourth network device, the second network device, and the second edge device, and may identify the first plurality of network devices associated with the first path (e.g., the third network device, the fourth network device, and the second network device). The first network device may cause the traceroute request to be provided to the third network device, the fourth network device, and the second network device. In some implementations, the first network device and the first plurality of network devices may be considered intermediate network devices between the first edge device and the second edge device.

As further shown in FIG. 1C, and by reference number 120, the first network device may receive a first plurality of responses indicating respective bit costs and energy efficiency identifiers associated with the first plurality of network devices. For example, the first plurality of network devices (e.g., the third network device, the fourth network device, and the second network device) may receive the traceroute request. The traceroute request may cause the first plurality of network devices to generate the first plurality of responses indicating the respective bit costs and the energy efficiency identifiers associated with the first plurality of network devices. In one example, the first plurality of responses indicating the respective bit costs and the energy efficiency identifiers associated with the first plurality of network devices may include the following information: P3.vendor-device.provider.net (172.29.126.19) 250.997 ms 250.925 ms 251.650 ms <MPLS:L=178220,E=3,S=0,T=1/L=13406,E=3,S=1,T=1>, <BitCost=0.003pJ/bit, Node Energy Cert=xx.yy.zz, 5*>; P4.vendor-device.provider.net (10.50.0.50) 250.806 ms 251.778 ms 244.822 ms <MPLS:L=13406,E=3,S=0,T=1/L=14409,E=3,S=1,T=1>, <BitCost=0.0015pJ/bit, Node Energy Cert=xx2.yy2.zz2, 5*>; and PE2.non-vendor.provider.net (10.32.0.91) 244.983 ms 245.137 ms 10.32.0.93 (10.32.0.93) 256.503 ms <BitCost=0.15pJ/bit, Node Energy Cert=xx4.yy4.zz4, 2*>.

In some implementations, each of the first plurality of responses indicating the respective bit costs and the energy efficiency identifiers associated with the first plurality of network devices may include an ICMP traceroute response, a UDP traceroute response, a TCP traceroute response, a Layer 2 CFM LTR message, and/or the like. In some implementations, the first plurality of responses may include TLV fields indicating the respective bit costs and the energy efficiency identifiers associated with the first plurality of network devices.

As further shown in FIG. 1C, and by reference number 125, the first network device may generate a first traceroute response that includes the response and the first plurality of responses. For example, the first network device may combine the response indicating the bit cost and the energy efficiency identifier associated with the first network device and the first plurality of responses indicating the respective bit costs and the energy efficiency identifiers associated with the first plurality of network devices to generate the first traceroute response. In some implementations, the first traceroute response may include an ICMP traceroute response, a UDP traceroute response, a TCP traceroute response, a Layer 2 CFM LTR message, and/or the like. In some implementations, the first traceroute response may include TLV fields indicating the respective bit costs and the energy efficiency identifiers associated with the first network device and the first plurality of network devices.

As further shown in FIG. 1C, and by reference number 130, the first network device may provide the first traceroute response to the first edge device. For example, the first network device may provide the first traceroute response to the first edge device, and the first edge device may receive the first traceroute response. The first traceroute response may indicate, to the first edge device, the energy efficiency associated with the first path through the network (e.g., via the first plurality of network devices). Alternatively, the first network device may generate the traceroute request and may utilize the first traceroute response to determine the energy efficiency associated with the first path through the network (e.g., via the first plurality of network devices).

As shown in FIG. 1D, and by reference number 135, the first network device may provide the traceroute request to a second plurality of network devices associated with a second path. For example, the first network device may identify the second path connecting the first edge device, the first network device, the fifth network device, the second network device, and the second edge device, and may identify the second plurality of network devices associated with the second path (e.g., the fifth network device and the second network device). The first network device may cause the traceroute request to be provided to the fifth network device and the second network device. In some implementations, the first network device and the second plurality of network devices may be considered intermediate network devices between the first edge device and the second edge device.

As further shown in FIG. 1D, and by reference number 140, the first network device may receive a second plurality of responses indicating respective bit costs and energy efficiency identifiers associated with the second plurality of network devices. For example, the second plurality of network devices (e.g., the fifth network device and the second network device) may receive the traceroute request. The traceroute request may cause the second plurality of network devices to generate the second plurality of responses indicating the respective bit costs and the energy efficiency identifiers associated with the second plurality of network devices. In one example, the second plurality of responses indicating the respective bit costs and the energy efficiency identifiers associated with the second plurality of network devices may include the following information: P5.non-vendor-device.provider.net (172.29.126.29) 250.997 ms 250.925 ms 251.650 ms; and PE2.non-vendor.provider.net (10.32.0.91) 244.983 ms 245.137 ms 10.32.0.93 (10.32.0.93) 256.503 ms <BitCost=0.15pJ/bit, Node Energy Cert=xx4.yy4.zz4, 2*>.

In some implementations, each of the second plurality of responses indicating the respective bit costs and the energy efficiency identifiers associated with the second plurality of network devices may include an ICMP traceroute response, a UDP traceroute response, a TCP traceroute response, a Layer 2 CFM LTR message, and/or the like. In some implementations, the second plurality of responses may include TLV fields indicating the respective bit costs and the energy efficiency identifiers associated with the second plurality of network devices.

As further shown in FIG. 1D, and by reference number 145, the first network device may generate a second traceroute response that includes the response and the second plurality of responses. For example, the first network device may combine the response indicating the bit cost and the energy efficiency identifier associated with the first network device and the second plurality of responses indicating the respective bit costs and the energy efficiency identifiers associated with the second plurality of network devices to generate the second traceroute response. In some implementations, the second traceroute response may include an ICMP traceroute response, a UDP traceroute response, a TCP traceroute response, a Layer 2 CFM LTR message, and/or the like. In some implementations, the second traceroute response may include TLV fields indicating the respective bit costs and the energy efficiency identifiers associated with the first network device and the second plurality of network devices.

As further shown in FIG. 1D, and by reference number 150, the first network device may provide the second traceroute response to the first edge device. For example, the first network device may provide the second traceroute response to the first edge device, and the first edge device may receive the second traceroute response. The second traceroute response may indicate, to the first edge device, the energy efficiency associated with the second path through the network (e.g., via the second plurality of network devices). Alternatively, the first network device may generate the traceroute request and may utilize the second traceroute response to determine the energy efficiency associated with the second path through the network (e.g., via the second plurality of network devices).

As shown in FIG. 1E, and by reference number 155, the first edge device may determine whether to utilize the first path or the second path based on the first traceroute response and the second traceroute response. For example, the first edge device may compare the energy efficiency of the first path (e.g., indicated in the first traceroute response) and the energy efficiency of the second path (e.g., indicated in the second traceroute response), and may determine whether to utilize the first path or the second path based on the comparison. In some implementations, the first edge device may determine to utilize the first path since the energy efficiency of the first path is better than the energy efficiency of the second path.

Alternatively, when the first network device generates the traceroute request, the first network device may determine whether to utilize the first path or the second path based on the first traceroute response and the second traceroute response. In such implementations, the first network device may compare the energy efficiency of the first path (e.g., indicated in the first traceroute response) and the energy efficiency of the second path (e.g., indicated in the second traceroute response), and may determine whether to utilize the first path or the second path based on the comparison. In some implementations, the first network device may receive (e.g., from the first edge device) traffic destined for the second edge device, and may select one of the first path or the second path for the traffic based on the energy efficiencies associated with the first path and the second path. The first network device may cause the traffic to be provided to the second edge device via the one of the first path or the second path. In one example, the first network device may cause the traffic to be provided to the second edge device via the first path since the energy efficiency of the first path is better than the energy efficiency of the second path.

FIG. 1F depicts example syntax associated with the first traceroute response generated by the first network device. As shown, the first traceroute response may include the following syntax indicating the respective bit costs and the energy efficiency identifiers associated with the first plurality of network devices:

CE1 [~]>traceroute -e ce2.mydomain.net
traceroute to ce2.mydomain.net (10.48.232.14), 30 hops max, 60 byte packets:

| | |
|---|---|
| 1. | PE1.vendor-device.provider.net (10.224.147.251) 0.736 ms 0.702 ms 0.681 ms |

<BitCost= 0.001pJ/bit, Node Energy Cert= xx1.xx2.., 5*>

| | |
|---|---|
| 2. | P3.vendor-device.provider.net (172.29.126.19) 250.997 ms 250.925 ms 251.650 |

ms <MPLS:L=178220,E=3,S=0,T=1/L=13406,E=3,S=1,T=1>, <BitCost = .003pJ/bit,
Node Energy Cert= xx.yy.zz, 5*>

| | |
|---|---|
| 3. | P4.vendor-device.provider.net (10.50.0.50) 250.806 ms 251.778 ms 244.822 ms |

<MPLS:L=13406,E=3,S=0,T=1/L=14409,E=3,S=1,T=1>, <BitCost = .0015pJ/bit,
Node Energy Cert= xx2.yy2.zz2, 5*>

| | |
|---|---|
| 4. | PE2.non-vendor.provider.net (10.32.0.91) 244.983 ms 245.137 ms 10.32.0.93 |

(10.32.0.93) 256.503 ms < BitCost = .15pJ/bit, Node Energy Cert= xx4.yy4.zz4, 2*>

| | |
|---|---|
| 5. | ce2.mydomain.net (10.48.232.14) 243.716 ms 244.567 ms 236.699 ms. |

FIG. 1G depicts example syntax associated with the second traceroute response generated by the first network device. As shown, the second traceroute response may include the following syntax indicating the respective bit costs and the energy efficiency identifiers associated with the second plurality of network devices:

CE1 [~]>traceroute -e ce2.mydomain.net
traceroute to ce2.mydomain.net (10.48.232.14), 30 hops max, 60 byte packets:

| | |
|---|---|
| 1. | PE1.vendor-device.provider.net (10.224.147.251) 0.736 ms 0.702 ms 0.681 ms |

<BitCost= 0.001pJ/bit, Node Energy Cert= xx1.xx2.., 5*>

| | |
|---|---|
| 2. | P5.non-vendor-device.provider.net (172.29.126.29) 250.997 ms 250.925 ms |

251.650 ms

| | |
|---|---|
| 3. | PE2.non-vendor.provider.net (10.32.0.91) 244.983 ms 245.137 ms 10.32.0.93 |

(10.32.0.93) 256.503 ms < BitCost = .15pJ/bit, Node Energy Cert= xx4.yy4.zz4, 2*>

| | |
|---|---|
| 4. | ce2.mydomain.net (10.48.232.14) 243.716 ms 244.567 ms 236.699 ms. |

FIG. 1H depicts an example traceroute response. As shown, the traceroute response may include TLV fields indicating an object payload, bit cost data, and an energy certificate (e.g., generated by a certifying authority).

In this way, the network device enables determining and utilizing energy efficient links and network devices in a network. For example, the network device may utilize OAM tools (e.g., traceroute and/or ping) to determine and utilize the energy efficient links and network devices in the network. To determine and utilize the bit cost metrics and the greenness metrics of links and network devices, the network device may enable bit cost metrics and green certificates of links and network devices to be included in traceroute requests/responses or ping requests/responses, as part of a protocol exchange with the links and the network devices. This will enable a network service provider to determine and utilize the energy efficient links and network devices in the network (e.g., for traffic path calculations). Thus, the network device conserves computing resources, networking resources, and/or the like that would otherwise have been consumed by failing to utilize bit cost metrics and greenness metrics for network devices and links of a network, utilizing energy inefficient network devices and/or links based on failing to utilize the bit cost metrics and the greenness metrics, handling customer complaints associated with failing to utilize the bit cost metrics and the greenness metrics, failing to satisfy government regulations based on failing to utilize the bit cost metrics and the greenness metrics, and/or the like.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

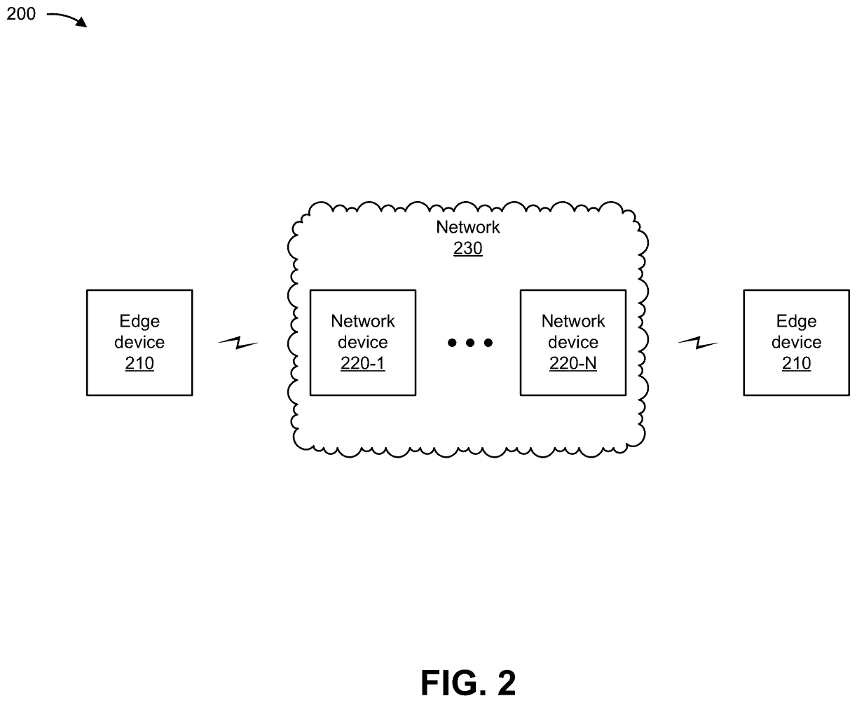

FIG. 2 is a diagram of an example environment 200 in which systems and/or methods described herein may be implemented. As shown in FIG. 2, environment 200 may include edge devices 210, a group of network devices 220 (shown as network device 220-1 through network device 220-N), and a network 230. Devices of the environment 200 may interconnect via wired connections, wireless connections, or a combination of wired and wireless connections.

An edge device 210 includes one or more devices capable of receiving, generating, storing, processing, and/or providing information, such as information described herein. For example, the edge device 210 may include a mobile phone (e.g., a smart phone or a radiotelephone), a laptop computer, a tablet computer, a desktop computer, a handheld computer, a gaming device, a wearable communication device (e.g., a smart watch, a pair of smart glasses, a heart rate monitor, a fitness tracker, smart clothing, smart jewelry, or a head mounted display), a network device, a server device, a group of server devices, or a similar type of device. In some implementations, the edge device 210 may receive network traffic from and/or may provide network traffic to other edge devices 210, via the network 230 (e.g., by routing packets using the network devices 220 as intermediaries).

A network device 220 includes one or more devices capable of receiving, processing, storing, routing, and/or providing traffic (e.g., a packet or other information or metadata) in a manner described herein. For example, the network device 220 may include a router, such as a label switching router (LSR), a label edge router (LER), an ingress router, an egress router, a provider router (e.g., a provider edge router or a provider core router), a virtual router, a route reflector, an area border router, or another type of router. Additionally, or alternatively, the network device 220 may include a gateway, a switch, a firewall, a hub, a bridge, a reverse proxy, a server (e.g., a proxy server, a cloud server, or a data center server), a load balancer, and/or a similar device. In some implementations, the network device 220 may be a physical device implemented within a housing, such as a chassis. In some implementations, the network device 220 may be a virtual device implemented by one or more computer devices of a cloud computing environment or a data center. In some implementations, a group of network devices 220 may be a group of data center nodes that are used to route traffic flow through the network 230.

The network 230 includes one or more wired and/or wireless networks. For example, the network 230 may include a packet switched network, a cellular network (e.g., a fifth generation (5G) network, a fourth generation (4G) network, such as a long-term evolution (LTE) network, a third generation (3G) network, a code division multiple access (CDMA) network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

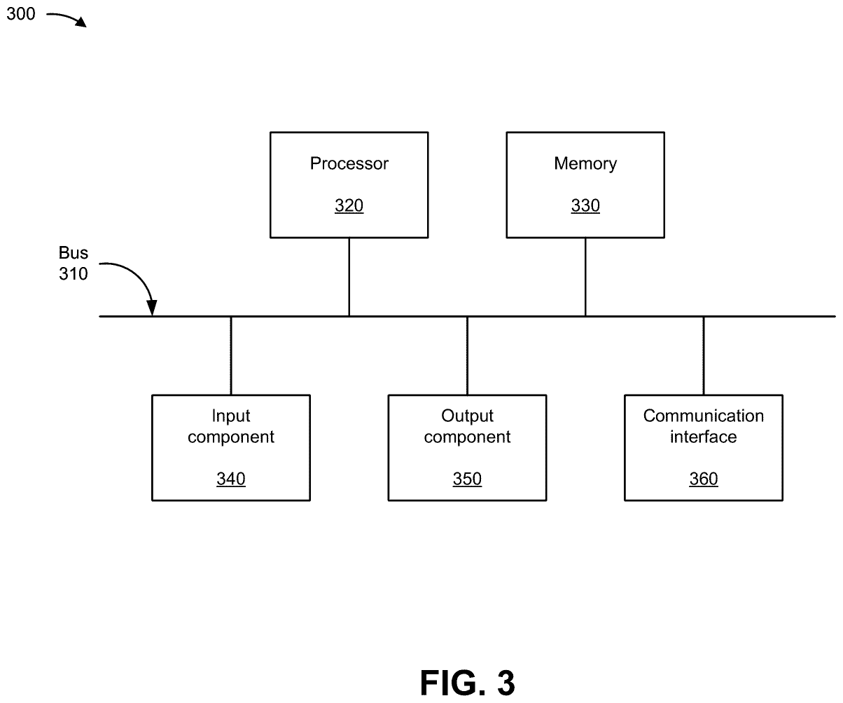

FIG. 3 is a diagram of example components of one or more devices of FIG. 2. The example components may be included in a device 300, which may correspond to the edge device 210 and/or the network device 220. In some implementations, the edge device 210 and/or the network device 220 may include one or more devices 300 and/or one or more components of the device 300. As shown in FIG. 3, the device 300 may include a bus 310, a processor 320, a memory 330, an input component 340, an output component 350, and a communication interface 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication interface 360 enables the device 300 to communicate with other devices via a wired connection and/or a wireless connection. For example, the communication interface 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

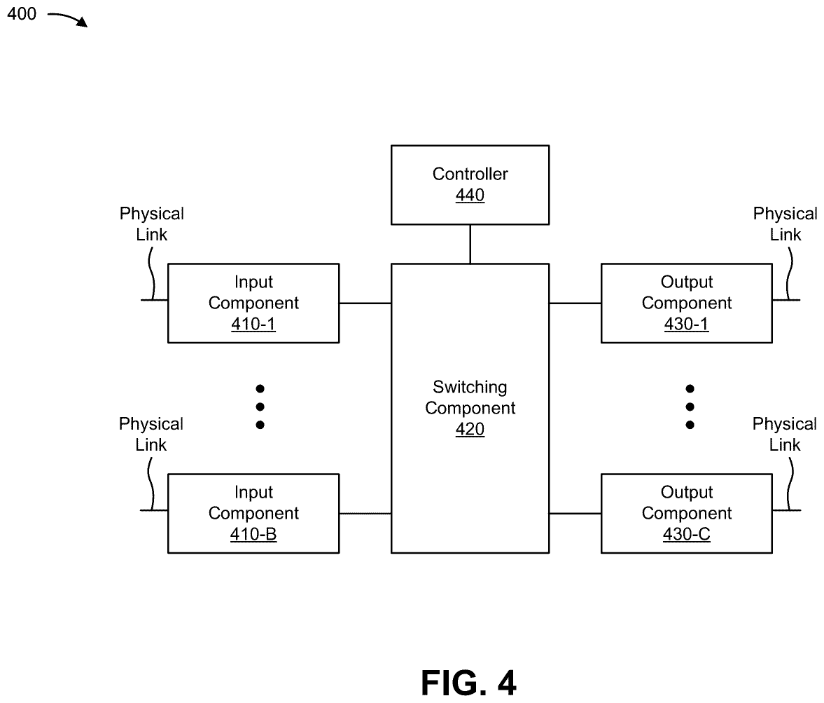

FIG. 4 is a diagram of example components of one or more devices of FIG. 2. The example components may be included in a device 400. The device 400 may correspond to the edge device 210 and/or the network device 220. In some implementations, the edge device 210 and/or the network device 220 may include one or more devices 400 and/or one or more components of the device 400. As shown in FIG. 4, the device 400 may include one or more input components 410-1 through 410-B (B≥1) (hereinafter referred to collectively as input components 410, and individually as input component 410), a switching component 420, one or more output components 430-1 through 430-C (C≥1) (hereinafter referred to collectively as output components 430, and individually as output component 430), and a controller 440.

The input component 410 may be one or more points of attachment for physical links and may be one or more points of entry for incoming traffic, such as packets. The input component 410 may process incoming traffic, such as by performing data link layer encapsulation or decapsulation. In some implementations, the input component 410 may transmit and/or receive packets. In some implementations, the input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, the device 400 may include one or more input components 410.

The switching component 420 may interconnect the input components 410 with the output components 430. In some implementations, the switching component 420 may be implemented via one or more crossbars, via busses, and/or with shared memories. The shared memories may act as temporary buffers to store packets from the input components 410 before the packets are eventually scheduled for delivery to the output components 430. In some implementations, the switching component 420 may enable the input components 410, the output components 430, and/or the controller 440 to communicate with one another.

The output component 430 may store packets and may schedule packets for transmission on output physical links. The output component 430 may support data link layer encapsulation or decapsulation, and/or a variety of higher-level protocols. In some implementations, the output component 430 may transmit packets and/or receive packets. In some implementations, the output component 430 may include an output line card that includes one or more packet processing components (e.g., in the form of integrated circuits), such as one or more IFCs, packet forwarding components, line card controller components, output ports, processors, memories, and/or output queues. In some implementations, the device 400 may include one or more output components 430. In some implementations, the input component 410 and the output component 430 may be implemented by the same set of components (e.g., and input/output component may be a combination of the input component 410 and the output component 430).

The controller 440 includes a processor in the form of, for example, a CPU, a GPU, an APU, a microprocessor, a microcontroller, a DSP, an FPGA, an ASIC, and/or another type of processor. The processor is implemented in hardware, firmware, or a combination of hardware and software. In some implementations, the controller 440 may include one or more processors that can be programmed to perform a function.

In some implementations, the controller 440 may include a RAM, a ROM, and/or another type of dynamic or static storage device (e.g., a flash memory, a magnetic memory, an optical memory, etc.) that stores information and/or instructions for use by the controller 440.

In some implementations, the controller 440 may communicate with other devices, networks, and/or systems connected to the device 400 to exchange information regarding network topology. The controller 440 may create routing tables based on the network topology information, may create forwarding tables based on the routing tables, and may forward the forwarding tables to the input components 410 and/or output components 430. The input components 410 and/or the output components 430 may use the forwarding tables to perform route lookups for incoming and/or outgoing packets.

The controller 440 may perform one or more processes described herein. The controller 440 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with the controller 440 from another computer-readable medium or from another device via a communication interface. When executed, software instructions stored in a memory and/or storage component associated with the controller 440 may cause the controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

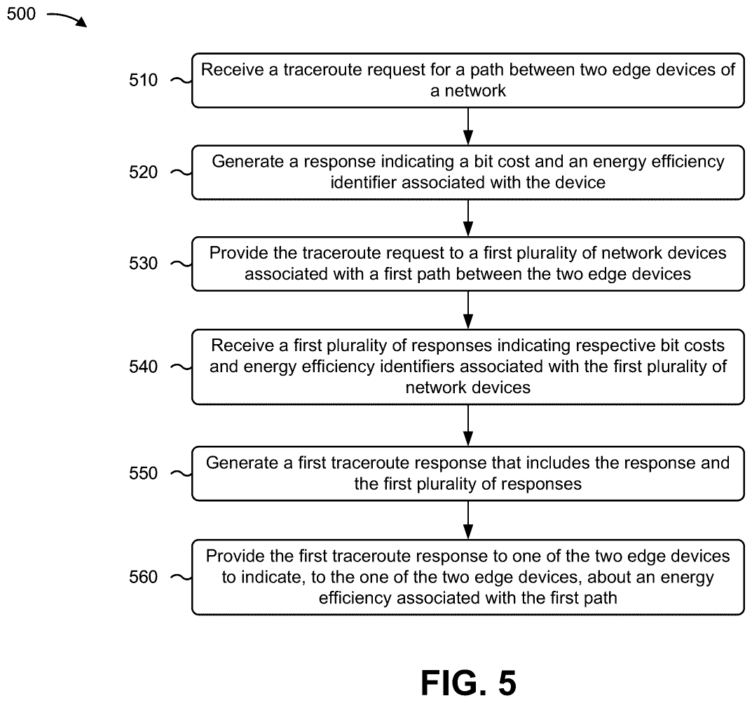

FIG. 5 is a flowchart of an example process 500 for determining and utilizing energy efficient links and network devices in a network. In some implementations, one or more process blocks of FIG. 5 may be performed by a device (e.g., the network device 220). In some implementations, one or more process blocks of FIG. 5 may be performed by another device or a group of devices separate from or including the device, such as an edge device (e.g., the edge device 210). Additionally, or alternatively, one or more process blocks of FIG. 5 may be performed by one or more components of the device 300, such as the processor 320, the memory 330, the input component 340, the output component 350, and/or the communication interface 360. Additionally, or alternatively, one or more process blocks of FIG. 5 may be performed by one or more components of the device 400, such as the input component 410, the switching component 420, the output component 430, and/or the controller 440.

As shown in FIG. 5, process 500 may include receiving a traceroute request for a path between two edge devices of a network (block 510). For example, the device may receive a traceroute request for a path between two edge devices of a network, as described above. In some implementations, the traceroute request includes one of an ICMP traceroute request, a UDP traceroute request, or a TCP traceroute request.

As further shown in FIG. 5, process 500 may include generating a response indicating a bit cost and an energy efficiency identifier associated with the device (block 520). For example, the device may generate a response indicating a bit cost and an energy efficiency identifier associated with the device, as described above. In some implementations, the energy efficiency identifier associated with the device includes an energy certificate rating associated with the device. In some implementations, the response includes TLV fields indicating the bit cost and the energy efficiency identifier of the device.

As further shown in FIG. 5, process 500 may include providing the traceroute request to a first plurality of network devices associated with a first path between the two edge devices (block 530). For example, the device may provide the traceroute request to a first plurality of network devices associated with a first path between the two edge devices, as described above. In some implementations, the device and the first plurality of network devices are intermediate network devices between the two edge devices.

As further shown in FIG. 5, process 500 may include receiving a first plurality of responses indicating respective bit costs and energy efficiency identifiers associated with the first plurality of network devices (block 540). For example, the device may receive a first plurality of responses indicating respective bit costs and energy efficiency identifiers associated with the first plurality of network devices, as described above. In some implementations, the first plurality of responses include TLV fields indicating the respective bit costs and the energy efficiency identifiers associated with the first plurality of network devices.

As further shown in FIG. 5, process 500 may include generating a first traceroute response that includes the response and the first plurality of responses (block 550). For example, the device may generate a first traceroute response that includes the response and the first plurality of responses, as described above.

As further shown in FIG. 5, process 500 may include providing the first traceroute response to one of the two edge devices to indicate, to the one of the two edge devices, an energy efficiency associated with the first path (block 560). For example, the device may provide the first traceroute response to one of the two edge devices to indicate, to the one of the two edge devices, an energy efficiency associated with the first path, as described above.

In some implementations, process 500 includes providing the traceroute request to a second plurality of network devices associated with a second path between the two edge devices, receiving a second plurality of responses indicating respective bit costs and energy efficiency identifiers associated with the second plurality of network devices, generating a second traceroute response that includes the response and the second plurality of responses, and providing the second traceroute response to the one of the two edge devices to indicate, to the one of the two edge devices, an energy efficiency associated with the second path.

In some implementations, the first traceroute response and the second traceroute response enable the one of the two edge devices to determine whether to utilize the first path or the second path. In some implementations, each of the energy efficiency identifiers associated with the first plurality of network devices and the second plurality of network devices includes an energy certificate rating. In some implementations, the second plurality of responses include TLV fields indicating the respective bit costs and the energy efficiency identifiers associated with the second plurality of network devices. In some implementations, the device and the second plurality of network devices are intermediate network devices between the two edge devices.

In some implementations, process 500 includes receiving traffic destined for one of the two edge devices, selecting one of the first path or the second path for the traffic based on the energy efficiencies associated with the first path and the second path, and causing the traffic to be provided to the one of the two edge devices via the one of the first path or the second path. In some implementations, process 500 includes receiving traffic destined for one of the two edge devices, selecting one of a plurality of paths for the traffic based on energy efficiencies associated with the plurality of paths, and causing the traffic to be provided to the one of the two edge devices via the one of the plurality of paths.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a traceroute request for a path between two edge devices of a network;
generating, by the device, a response indicating a bit cost and an energy efficiency identifier associated with the device;
providing, by the device, the traceroute request to a first plurality of network devices associated with a first path between the two edge devices;
receiving, by the device, a first plurality of responses indicating respective bit costs and energy efficiency identifiers associated with the first plurality of network devices;
generating, by the device, a first traceroute response that includes the response and the first plurality of responses; and
providing, by the device, the first traceroute response to one of the two edge devices to indicate, to the one of the two edge devices, an energy efficiency associated with the first path.

2. The method of claim 1, further comprising:
providing the traceroute request to a second plurality of network devices associated with a second path between the two edge devices;
receiving a second plurality of responses indicating respective bit costs and energy efficiency identifiers associated with the second plurality of network devices;
generating a second traceroute response that includes the response and the second plurality of responses; and
providing the second traceroute response to the one of the two edge devices to indicate, to the one of the two edge devices, an energy efficiency associated with the second path.

3. The method of claim 2, wherein the first traceroute response and the second traceroute response enable the one of the two edge devices to determine whether to utilize the first path or the second path.

4. The method of claim 2, wherein each of the respective energy efficiency identifiers associated with the first plurality of network devices and the second plurality of network devices includes an energy certificate rating.

5. The method of claim 2, wherein the second plurality of responses include type-length-value fields indicating the respective bit costs and the energy efficiency identifiers associated with the second plurality of network devices.

6. The method of claim 2, wherein the device and the second plurality of network devices are intermediate network devices between the two edge devices.

7. The method of the claim 2, further comprising:
receiving traffic destined for one of the two edge devices;
selecting one of the first path or the second path for the traffic based on the energy efficiencies associated with the first path and the second path; and
causing the traffic to be provided to the one of the two edge devices via the one of the first path or the second path.

8. A device, comprising:
one or more memories; and
one or more processors to:
receive a traceroute request for a path between two edge devices of a network;
generate a response indicating a bit cost and an energy efficiency identifier associated with the device;
provide the traceroute request to a plurality of network devices associated with a plurality of paths between the two edge devices;
receive a plurality of responses indicating respective bit costs and energy efficiency identifiers associated with the plurality of network devices;
generate a traceroute response that includes the response and the plurality of responses; and
provide the traceroute response to one of the two edge devices to indicate, to the one of the two edge devices, energy efficiencies associated with the plurality of paths.

9. The device of claim 8, wherein the energy efficiency identifier associated with the device includes an energy certificate rating associated with the device.

10. The device of claim 8, wherein the traceroute request includes one of an Internet control message protocol traceroute request, a user datagram protocol traceroute request, or a transmission control protocol traceroute request.

11. The device of claim 8, wherein the response includes type-length-value fields indicating the bit cost and the energy efficiency identifier of the device.

12. The device of claim 8, wherein the plurality of responses include type-length-value fields indicating the respective bit costs and the energy efficiency identifiers associated with the plurality of network devices.

13. The device of claim 8, wherein the device and the plurality of network devices are intermediate network devices between the two edge devices.

14. The device of claim 8, wherein the one or more processors are further to:
receive traffic destined for one of the two edge devices;
select one of the plurality of paths for the traffic based on the energy efficiencies associated with the plurality of paths; and
cause the traffic to be provided to the one of the two edge devices via the one of the plurality of paths.

15. A non-transitory computer-readable medium storing a set of instructions, the set of instructions comprising:
one or more instructions that, when executed by one or more processors of a device, cause the device to:
receive a traceroute request for a path between two edge devices of a network;
generate a response indicating a bit cost and an energy efficiency identifier associated with the device;
provide the traceroute request to a first plurality of network devices associated with a first path between the two edge devices;
receive a first plurality of responses indicating respective bit costs and energy efficiency identifiers associated with the first plurality of network devices;
generate a first traceroute response that includes the response and the first plurality of responses;
provide the first traceroute response to one of the two edge devices to indicate, to the one of the two edge devices, an energy efficiency associated with the first path;
provide the traceroute request to a second plurality of network devices associated with a second path between the two edge devices;
receive a second plurality of responses indicating respective bit costs and energy efficiency identifiers associated with the second plurality of network devices;
generate a second traceroute response that includes the response and the second plurality of responses; and
provide the second traceroute response to the one of the two edge devices to indicate, to the one of the two edge devices, an energy efficiency associated with the second path.

16. The non-transitory computer-readable medium of claim 15, wherein the first traceroute response and the second traceroute response enable the one of the two edge devices to determine whether to utilize the first path or the second path.

17. The non-transitory computer-readable medium of claim 15, wherein each of the energy efficiency identifiers associated with the first plurality of network devices and the second plurality of network devices includes an energy certificate rating.

18. The non-transitory computer-readable medium of claim 15, wherein the second plurality of reponses include type-length-value fields indicating the respective bit costs and the energy efficiency identifiers associated with the second plurality of network devices.

19. The non-transitory computer-readable medium of claim 15, wherein the device and the second plurality of network devices are intermediate network devices between the two edge devices.

20. The non-transitory computer-readable medium of claim 15, wherein the one or more instructions further cause the device to:
receive traffic destined for one of the two edge devices;
select one of the first path or the second path for the traffic based on the energy efficiencies associated with the first path and the second path; and
cause the traffic to be provided to the one of the two edge devices via the one of the first path or the second path.
